(19) United States
(12) Patent Application Publication
(10) Pub. No.: US 2012/0073356 A1
(43) Pub. Date: Mar. 29, 2012

(54) AIR-FUEL RATIO SENSOR

(76) Inventors: Hiroki Nishijima, Aichi-ken (JP); Takechi Hirabayashi, Aichi-ken (JP); Haruki Kondo, Aichi-ken (JP); Yasufumi Suzuki, Aichi-ken (JP)

(21) Appl. No.: 13/322,945

(22) PCT Filed: Apr. 15, 2010
(86) PCT No.: PCT/IB2010/000854

§ 371 Date: Nov. 29, 2011

(30) Foreign Application Priority Data
May 29, 2009 (JP) 2009-130889

(51) Int. Cl. G01M 15/10

(52) U.S. Cl. 73/23.32

(57) ABSTRACT

An air-fuel ratio sensor includes a solid electrolyte layer, a measuring electrode laminated on a first face of the solid electrolyte layer, a reference electrode laminated on a second face of the solid electrolyte layer which is different from the first face thereof, such that the reference electrode and the measuring electrode are opposed to each other with the solid electrolyte layer interposed therebetween, a porous diffusion resistance layer that permits gas to pass therethrough and covers the measuring electrode, and a catalyst layer including a catalyst metal and a base material on which the catalyst metal is supported. The catalyst layer permits gas to pass therethrough and covers the porous diffusion resistance layer. The catalyst metal is a platinum-palladium-rhodium alloy, and contains 2 to 9 mass % of rhodium when the overall amount of the catalyst layer is represented as 100 mass %.

### BACKGROUND OF THE INVENTION

1. Field of the Invention

The invention relates to an air-fuel ratio sensor mounted in an exhaust path of a vehicle for detecting various components contained in exhaust gas.

2. Description of the Related Art

An air-fuel ratio sensor (or so-called “A/F sensor”) is mounted in an exhaust path of a vehicle, and is operable to detect the concentration of oxygen contained in exhaust gas of the vehicle. The air-fuel ratio sensor is generally used for combustion control of an internal combustion engine of the vehicle. Therefore, the air-fuel ratio sensor is required to have the ability to speedily deal with (respond to) changes in the concentration of oxygen in the exhaust gas.

The air-fuel ratio sensor has two electrodes (a measuring electrode and a reference electrode) provided on one surface and the other, opposite surface of a solid electrolyte, respectively. As one type or example of the air-fuel ratio sensor, a porous diffusion resistance layer defines a part of (or the whole of) an exhaust-gas chamber that partitions the vicinity of the measuring electrode from the outside of the air-fuel ratio sensor. In this case, exhaust gas present in the outside of the air-fuel ratio sensor passes through pores formed in the porous diffusion resistance layer, and is introduced into the exhaust-gas chamber. Thus, the porous diffusion resistance layer provides exhaust-gas channels that extend from the outside of the sensor to the exhaust-gas chamber, and serves to physically restrict the amount of exhaust gas that enters the exhaust-gas chamber and reaches the measuring electrode.

In the meantime, exhaust gas contains low-molecular-weight components and high-molecular-weight components, and the low-molecular-weight components (such as molecules of hydrogen) diffuse through the porous diffusion resistance layer at higher speeds than the high-molecular-weight components (such as molecules of oxygen). Therefore, there are cases where the concentration of oxygen in exhaust gas that reaches the measuring electrode via the porous diffusion resistance layer is different from the concentration of oxygen in the actual exhaust gas. More specifically, the concentration of hydrogen in the vicinity of the measuring electrode is higher than that of hydrogen in the actual exhaust gas, and the concentration of oxygen in the vicinity of the measuring electrode is lower than that of oxygen in the actual exhaust gas. Therefore, a difference (which will be referred to as “measurement-value deviation”) arises between the oxygen concentration of the exhaust gas measured by the air-fuel ratio sensor and the oxygen concentration of the actual exhaust gas.

For example, it is known that, even when the air-fuel ratio of the actual exhaust gas is equal to 14.5, which is the stoichiometric ratio (i.e., the theoretical air-fuel ratio), the air-fuel ratio calculated based on the measurement value of the air-fuel ratio sensor is richer than the stoichiometric ratio. When the measurement-value deviation occurs (in particular, when the air-fuel ratio calculated based on the measurement value of the air-fuel ratio deviates from the stoichiometric ratio in the case where the air-fuel ratio of the actual exhaust gas is equal to the stoichiometric ratio, which will be referred to as “deviation from the stoichiometric ratio”), the combustion control of the internal combustion engine may not be appropriately performed.

It has been proposed (in, for example, Japanese Patent Application Publication No. 2007-199046 (JP-A-2007-199046)) to provide a catalyst layer in a further outer portion of the air-fuel ratio sensor than the porous diffusion resistance layer (i.e., on the outer surface of the porous diffusion resistance layer remote from the exhaust-gas chamber), so that catalyst metal supported on the catalyst layer promotes combustion of hydrogen gas. According to this technology, the catalyst metal promotes combustion of hydrogen gas, so that most of hydrogen gas is inhibited from reaching the measuring electrode, and a deviation of the measurement value of the air-fuel ratio sensor due to the presence of hydrogen gas can be reduced or eliminated.

JP-A-2007-199046 as identified above discloses that platinum (Pt), palladium (Pd) and rhodium (Rh) are used as catalyst metal supported on the catalyst layer, and that Pd is involved in a delay in response of the air-fuel ratio sensor and the above-mentioned measurement-value deviation. Namely, if the content of Pd is equal to or smaller than a specified value, the delay in response of the air-fuel ratio sensor can be curbed or reduced. If the content of Pd exceeds another specified value, a deviation of the air-fuel ratio calculated based on the measurement value of the air-fuel ratio sensor from the stoichiometric ratio to the rich side, after a long-term use of the sensor, can be reduced.

However, the air-fuel ratio sensor of the above type cannot be completely free from the delay in response and the measurement-value deviation. Accordingly, it has been desired to develop an air-fuel ratio sensor that can further reduce the delay in response and the measurement-value deviation.

### SUMMARY OF THE INVENTION

The invention provides an air-fuel ratio sensor that has a catalyst layer and can reduce a delay in response and measurement-value deviation.

An air-fuel ratio sensor according to one aspect of the invention includes a solid electrolyte layer, a measuring electrode laminated on a first face of the solid electrolyte layer, a reference electrode laminated on a second face of the solid electrolyte layer which is different from the first face thereof, such that the reference electrode and the measuring electrode are opposed to each other with the solid electrolyte layer interposed therebetween, a porous diffusion resistance layer that permits gas to pass therethrough and covers the measuring electrode, and a catalyst layer including a catalyst metal and a base material on which the catalyst metal is supported. The catalyst layer permits gas to pass therethrough, and covers the porous diffusion resistance layer. In the air-fuel ratio sensor, the catalyst metal is a platinum-palladium-rhodium alloy, and contains 2 to 9 mass % of the rhodium when the overall amount of the catalyst layer is represented as 100 mass %.

The rhodium may be contained in the amount of 2 to 5 mass % when the overall amount of the catalyst layer is represented as 100 mass %. Also, the rhodium may be contained in the amount of 2 to 3 mass % when the overall amount of the catalyst layer is represented as 100 mass %. The palladium may be contained in the amount of 2 to 65 mass % when the overall amount of the catalyst layer is represented as 100 mass %. Also, the palladium may be contained in the amount of 5 to 40 mass % when the overall amount of the catalyst layer is represented as 100 mass %.

In the air-fuel ratio sensor as described above, the mass ratio of the palladium to the platinum in the platinum-palladium-rhodium alloy may be 1:4 to 5:5.

The catalyst layer may have an average pore size of 0.1 μm to 10 μm. The catalyst layer may have a porosity of 40% to 70%. The catalyst layer may have a gas flow channel length of 10 μm to 300 μm. Alumina may be used as a material of the base material, and the catalyst layer may have an average particle size of 1 μm to 10 μm. The porous diffusion resistance layer may cooperate with the solid electrolyte layer to cover the measuring electrode. The air-fuel ratio sensor may further include a shield layer that inhibits gas from passing therethrough, and that cooperates with the porous diffusion resistance layer and the solid electrolyte layer to cover the whole of the measuring electrode. The catalyst layer may cover the entire area of exposed faces of the porous diffusion resistance layer.

The inventors of the present invention have found, as a result of studies, that Rh among components (Pt, Pd, Rh) of catalyst metal supported on the catalyst layer is involved in a delay in response.

Rh is mixed into the catalyst metal so as to suppress or prevent aggregation or evaporation of the catalyst metal at a high-temperature lean atmosphere. On the other hand, Rh adsorbs oxygen (has a large oxygen storage capacity); therefore, mixing Rh into the catalyst metal results in a delay in response of the air-fuel ratio sensor when the air-fuel ratio changes from rich to lean or when the air-fuel ratio changes from lean to rich. Namely, even if the air-fuel ratio of the actual exhaust gas (indicated by the two-dot chain line in FIG. 1) gradually changes from lean to rich, as shown in FIG. 1, the air-fuel ratio (indicated by the solid line in FIG. 1) calculated based on the output value of the air-fuel ratio sensor temporarily stops changing at around the stoichiometric point, and then changes with a delay with respect to changes in the air-fuel ratio of the actual exhaust gas. This may occur for the following reasons.

When the air-fuel ratio changes from rich to lean, oxygen in the exhaust gas is initially adsorbed onto Rh. Therefore, when the air-fuel ratio changes from rich to lean, the concentration of oxygen in the vicinity of the measuring electrode becomes lower than the actual oxygen concentration. The oxygen adsorbed by Rh when the air-fuel ratio turns lean is dissociated from Rh and reaches the vicinity of the measuring electrode after the air-fuel ratio changes from lean to rich. Therefore, immediately after the air-fuel ratio changes from lean to rich, the concentration of oxygen in the vicinity of the measuring electrode becomes higher than the actual oxygen concentration. Namely, the concentration of rich gas in the vicinity of the measuring electrode becomes lower than the concentration of rich gas in the actual exhaust gas. Thus, mixing of Rh into the catalyst metal is considered as a cause of the delay in response of the air-fuel ratio sensor.

If, on the other hand, Rh is not contained in the catalyst metal, aggregation or evaporation of the catalyst metal under a high-temperature lean atmosphere cannot be sufficiently curbed or prevented, and it is thus difficult to provide the catalyst layer with a sufficient catalyzing capability.

In the air-fuel ratio sensor according to the present invention, Rh is used as a catalyst metal supported on the catalyst layer, and the amount of Rh supported is controlled to within the optimum range, so that the catalyst layer is provided with a sufficient catalyzing capability, and a delay in response and measurement-value deviations from the actual values can be reduced.

More specifically, in the air-fuel ratio sensor of the invention, the percentage of Rh with respect to the overall amount of the catalyst layer is made equal to or less than 9 mass %, so that a delay in response can be reduced or prevented.

Also, in the air-fuel ratio of the invention, the percentage of Rh with respect to the overall amount of the catalyst layer is made equal to or greater than 2 mass %, so that measurement-value deviations can be further reduced. Namely, Rh contained in the catalyst layer adsorbs oxygen, and has a high ability to oxidize reducing gas. Therefore, a deviation of the stoichiometric ratio to the rich side can be reduced or avoided by mixing a sufficiently large amount of Rh into the catalyst layer.

The use of the catalyst metal in the form of an alloy of Pt, Pd and Rh in the air-fuel ratio sensor of the present invention leads to an improvement in the stability of the catalyst metal and a further improvement in the catalyzing capability of the catalyst layer.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a graph that schematically shows how a delay in response of an air-fuel ratio sensor occurs;

FIG. 2 is a cutaway front view schematically showing an air-fuel ratio sensor according to a first embodiment (Example 1) of the invention;

FIG. 3 is a cross-sectional view schematically showing the air-fuel ratio sensor according to the first embodiment of the invention, in a section taken along line A-A in FIG. 2;

FIG. 4 is a graph showing the results of oxygen storage capacity measurements and response delay time measurements made on Examples of the invention and Comparative Examples;

FIG. 5 is a graph showing the results of 50% conversion temperature measurements and stoichiometric-ratio determination accuracy measurements made on Examples of the invention and Comparative Examples; and

FIG. 6 is a graph showing the relationship between the oxygen storage capacity and 50% conversion temperature of the catalyst metal, and the percentage of Rh contained in the catalyst metal, with respect to Examples of the invention and Comparative Examples.

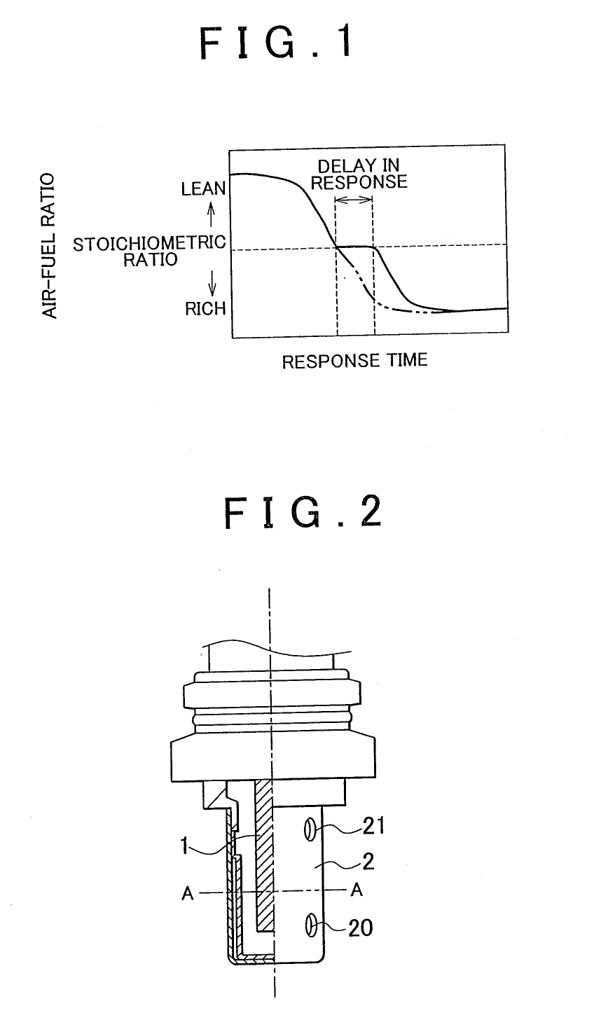

### DETAILED DESCRIPTION OF THE PREFERRED EMBODIMENTS

Air-fuel ratio sensors according to some embodiments of the invention will be specifically described.

As shown in FIG. 2, an air-fuel ratio sensor according to a first embodiment (Example 1) of the invention has a sensor element 1 and a case body 2.

The case body 2 is made of a metal, such as stainless steel or inconel, and is generally shaped like a cup. Case-side gas inlets 20, 21 in the form of through-holes are formed in a side wall of the case body 2. A case-side gas outlet (not shown) in the form of a through-hole is formed in a bottom wall of the case body 2. The case-side gas inlet 20 is an inlet through which exhaust gas flows from the outside to the inside of the case body 2, and the case-side gas inlet 21 is an inlet through which the air flows from the outside to the inside of the case body 2. The case-side gas outlet is an outlet through which the exhaust gas flows from the inside to the outside of the case body 2.

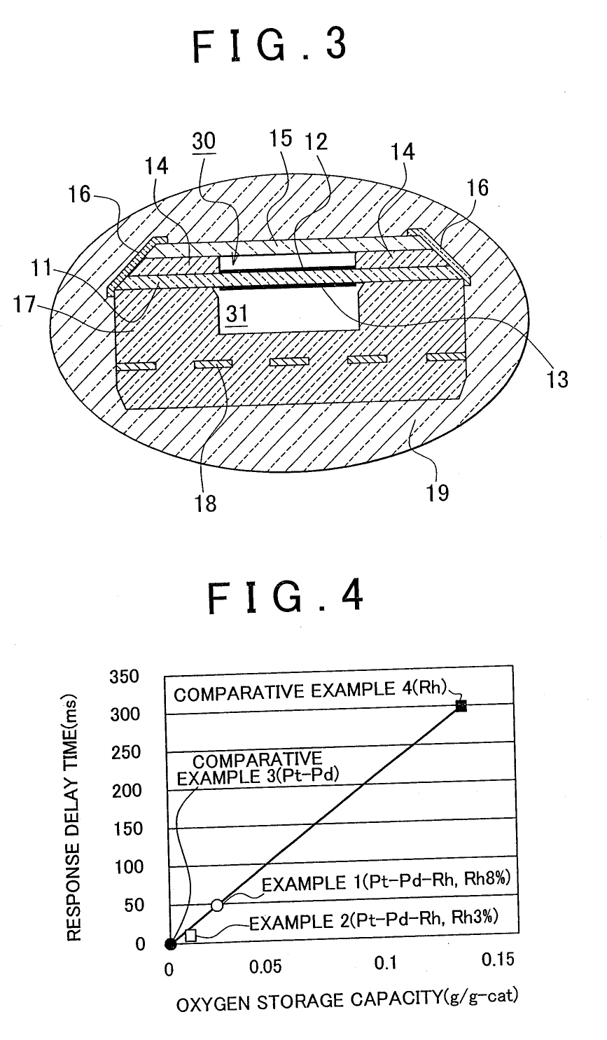

As shown in FIG. 3, the sensor element 1 has a solid electrolyte layer 11, a measuring electrode 12, a reference electrode 13, a porous diffusion resistance layer 14, a shield layer 15, a catalyst layer 16, an air-chamber defining layer 17, a heater 18, and a protective layer 19. In the explanation of FIG. 3, the upside, downside and lateral direction as viewed in the drawing (FIG. 3) will be referred to as the upside, downside and lateral direction of the sensor element 1, and faces of the sensor element 1 which face upward, downward and laterally will be referred to as the upper face, lower face and side faces, respectively. It is, however, to be understood that the directions of the sensor element 1 are not limited to those as shown in FIG. 3.

The solid electrolyte layer 11 is made of a mixture of zirconia and yttria, and is generally shaped like a plate. The measuring electrode 12 is laminated on the upper face of the solid electrolyte layer 11. The reference electrode 13 is laminated on the lower face of the solid electrolyte layer 11. Thus, the measuring electrode 12, solid electrolyte layer 11 and the reference electrode 13 are laminated on each other in the direction of the thickness of the solid electrolyte layer 11, such that the solid electrolyte layer 11 is sandwiched by and between the measuring electrode 12 and the reference electrode 13. The measuring electrode 12 and the reference electrode 13 are formed of platinum (Pt), and are generally shaped like plates.

The porous diffusion resistance layer 14, as well as the measuring electrode 12, is laminated on the upper face of the solid electrolyte layer 11. The porous diffusion resistance layer 14 is in the form of a generally U-shaped plate when viewed in the direction of lamination. The porous diffusion resistance layer 14 is positioned so as to surround side faces of the measuring electrode 12. Thus, the porous diffusion resistance layer 14 covers the side faces of the measuring electrode 12. The porous diffusion resistance layer 14 is composed of alumina particles.

The shield layer 15 is laminated on the upper face of the porous diffusion resistance layer 14. The shield layer 15 is a dense layer formed of alumina, which does not permit gas to flow therethrough. The measuring electrode 12 of the air-fuel ratio sensor of the first embodiment is placed inside an exhaust-gas chamber 30 that is defined by the shield layer 15, porous diffusion resistance layer 14 and the solid electrolyte layer 11.

The catalyst layer 16 is laminated on side faces of the shield layer 15, side faces of the porous diffusion resistance layer 14 and side faces of the solid electrolyte layer 11. Namely, the catalyst layer 16 is laminated so as to cover the entire areas of exposed faces of the porous diffusion resistance layer 14 and the solid electrolyte layer 11. The catalyst layer 16 has a base material and a catalyst metal. The catalyst metal, which consists of a Pt—Pd—Rh alloy, is supported on a surface of the base material and the inside thereof. The Pt—Pd—Rh alloy as the catalyst metal is formed by mixing Pt, palladium (Pd) and rhodium (Rh) in the mass ratio of Pt:Pd:Rh=45:45:10. The Pt—Pd—Rh alloy used in the air-fuel ratio sensor of the first embodiment amounts to 80 mass % when the overall amount of the catalyst layer 16 is represented as 100 mass %. Also, 8 mass % of Rh is contained in the catalyst layer 16 when the overall amount of the catalyst layer 16 is represented as 100 mass %. The porosity of the catalyst layer 16 is about 20%, and the length of gas flow channels in the catalyst layer 16 is about 10 μm. The catalyst layer 16 is composed of the Pt—Pd—Rh alloy having the average particle size of 100 nm or larger and smaller than 500 nm, and alumina particles and an inorganic adhesive having the average particle size of 1 μm or smaller. The catalyst layer 16 is formed by mixing the alumina particles and the alloy in an organic solvent, and drying and firing the mixture. The protective layer 19, which will be described later, is formed on one face of the catalyst layer 16 opposite to the other face thereof on which the shield layer 15, porous diffusion resistance layer 14 and the solid electrolyte layer 11 are located.

The air-chamber defining layer 17 is laminated on the lower face of the solid electrolyte layer 11. Like the shield layer 15, the air-chamber defining layer 17 is a dense layer formed of alumina, which does not permit gas to flow therethrough. The reference electrode 13 of the air-fuel ratio sensor of the first embodiment is placed inside an air chamber 31 that is defined by the air-chamber defining layer 17 and the solid electrolyte layer 11. The air or atmosphere serving as reference gas is introduced into the air chamber 31. A heater 18 is embedded in the air-chamber defining layer 17.

The protective layer 19 is formed from alumina particles having the average particle size of 4 μm or larger and 20 μm or smaller (i.e., in the range of 4 μm to 20 μm), and permits gas to flow therethrough. The length of gas flow channels in the protective layer 19 is in the range of about 100 μm to 1 mm. As shown in FIG. 3, the protective layer 19 covers the whole laminated structure of the sensor element, which consists of the solid electrolyte layer 11, measuring electrode 12, reference electrode 13, porous diffusion resistance layer 14, shield layer 15, catalyst layer 16, air-chamber defining layer 17, and the heater 18.

The operation of the air-fuel ratio sensor of the first embodiment will be described.

Exhaust gas emitted from an internal combustion engine of a vehicle flows through an exhaust path and reaches the air-fuel ratio sensor. Then, the exhaust gas flows into the interior of the case body 2 through the case-side gas inlet 20, passes through the protective layer 19, and reaches the catalyst layer 16. The catalyst metal (Pt—Pd—Rh alloy) of the catalyst layer 16 is heated by the heater 18 to a temperature level at which the catalyst is activated. Therefore, hydrogen gas contained in the exhaust gas that has reached the catalyst layer 16 reacts with oxygen gas (i.e., burns) by catalysis of the catalyst metal. As a result, substantially no hydrogen gas is contained in the exhaust gas that has passed through the catalyst layer 16. The exhaust gas that has passed through the catalyst layer 16 then passes through the porous diffusion resistance layer 14, and is introduced into the exhaust-gas chamber 30. The exhaust gas introduced into the exhaust-gas chamber 30 (namely, exhaust gas from which hydrogen gas is removed by the catalyst layer 16) is brought into contact with the measuring electrode 12. Oxygen contained in the exhaust gas passes through the measuring electrode 12 and the solid electrolyte layer 11, and reaches the reference electrode 13. The concentration of oxygen in the exhaust gas is measured based on electric current produced when oxygen reaches the reference electrode 13.

As described above, hydrogen gas in the exhaust gas burns when it passes through the catalyst layer 16. Therefore, the air-fuel ratio sensor of the first embodiment is less likely or unlikely to suffer from a problem that hydrogen gas reaches the measuring electrode 12 in a larger amount (or at a higher rate) than other components of the exhaust gas. Accordingly, a delay in response can be reduced or prevented in the air-fuel ratio sensor of the first embodiment. Also, the air-fuel ratio sensor of the first embodiment is less likely or unlikely to suffer from a problem that there is a difference (which will be called “measurement-value deviation”) between the oxygen concentration of exhaust gas measured by the air-fuel ratio sensor and the oxygen concentration of the actual exhaust gas, namely, a problem that there is a difference between the air-fuel ratio of the actual exhaust gas and the air-fuel ratio calculated based on the measurement values of the air-fuel ratio sensor. In particular, the air-fuel ratio sensor of this embodiment makes it possible to reduce or eliminate a deviation (which will be called “deviation from the stoichiometric ratio”) of the air-fuel ratio calculated based on the measurement values of the air-fuel ratio sensor from the stoichiometric ratio when the air-fuel ratio of the actual exhaust gas is equal to the stoichiometric ratio.

In the air-fuel ratio sensor of the first embodiment, the amount of Rh in the catalyst metal (i.e., Pt—Pd—Rh alloy) contained in the catalyst layer 16 is controlled to a sufficiently small value so that a delay in response of the sensor, which is derived from Rh in the catalyst metal, can be reduced or prevented.

In the air-fuel ratio sensor of the first embodiment, Pt, Pd and Rh of the catalyst metal are present in the form of an alloy, thus assuring excellent stability of the catalyst metal. For example, evaporation of Pt, which would occur when the air-fuel ratio is lean, can be curbed or avoided. Thus, according to the first embodiment, the durability of the catalyst metal is improved, and the durability of the air-fuel ratio sensor itself is also improved.

In the air-fuel ratio sensor of the first embodiment, the amount of Rh in the catalyst metal is controlled to a sufficiently large value so that evaporation and aggregation of Pt and Pd at high temperatures under a lean atmosphere can be curbed or avoided, and a deviation of the air-fuel ratio from the stoichiometric ratio to the lean side after a long-term use can be reduced or eliminated.

An air-fuel ratio sensor according to a second embodiment (Example 2) of the invention is identical with the air-fuel ratio sensor of the first embodiment (Example 1), except for the percentage of Rh in the Pt—Pd—Rh alloy. The Pt—Pd—Rh alloy used in the air-fuel ratio sensor of the second embodiment contains 3 mass % of Rh when the overall amount of the catalyst layer 16 is represented as 100 mass %.

An air-fuel ratio sensor according to a third embodiment (Example 3) of the invention is identical with the air-fuel ratio sensor of the first embodiment (Example 1), except for the percentage of Rh in the Pt—Pd—Rh alloy. The Pt—Pd—Rh alloy used in the air-fuel ratio sensor of the third embodiment contains 2.5 mass % of Rh when the overall amount of the catalyst layer 16 is represented as 100 mass %.

An air-fuel ratio sensor of Comparative Example 1 is identical with the air-fuel ratio sensor of the first embodiment (Example 1), except for the percentage of Rh in the Pt—Pd—Rh alloy. The Pt—Pd—Rh alloy used in the air-fuel ratio sensor of Comparative Example 1 contains 1.8 mass % of Rh when the overall amount of the catalyst layer 16 is represented as 100 mass %.

An air-fuel ratio sensor of Comparative Example 2 is identical with the air-fuel ratio sensor of the first embodiment (Example 1), except for the percentage of Rh in the Pt—Pd—Rh alloy. The Pt—Pd—Rh alloy used in the air-fuel ratio sensor of Comparative Example 2 contains 9.5 mass % of Rh when the overall amount of the catalyst layer 16 is represented as 100 mass %.

An air-fuel ratio sensor of Comparative Example 3 is identical with the air-fuel ratio sensor of the first embodiment (Example 1), except that a Pt—Pd alloy is used as the catalyst metal of the catalyst layer. The Pt—Pd alloy used in the air-fuel ratio sensor of Comparative Example 3 contains Pt and Pd in a mass ratio of 1:1.

An air-fuel ratio sensor of Comparative Example 4 is identical with the air-fuel ratio sensor of the first embodiment (Example 1), except that Rh is used as the catalyst metal of the catalyst layer.

An air-fuel ratio sensor of Comparative Example 5 is identical with the air-fuel ratio sensor of the first embodiment (Example 1), except that Pt is used as the catalyst metal of the catalyst layer.

### Performance Evaluations

The oxygen storage capacity and 50% conversion temperature of the catalyst layer used in each of the air-fuel ratio sensors of Example 1 through Example 3 and the air-fuel ratio sensors of Comparative Example 1 through Comparative Example 5 were measured. Also, the accuracy in the determination of the stoichiometric ratio and the response delay time were measured with respect to the air-fuel ratio sensors of Example 1 through Example 3 and the air-fuel ratio sensors of Comparative Example 1 through Comparative Example 5.

### 1. Oxygen Storage Capacity Measurements

The catalyst metal used in each of the air-fuel ratio sensors of Examples 1, 2 and the air-fuel ratio sensors of Comparative Examples 1-4 was oxidized in a high-temperature oxidizing atmosphere. Then, reducing gas, such as H₂, was passed through the catalyst metal, so that oxygen adsorbed on the catalyst metal was dissociated from the catalyst metal. A change in the mass at this time was measured by thermogravimetric analysis, and the oxygen storage capacity (g/g^{-cat}) of the catalyst metal was measured. The results of the oxygen storage capacity measurements are shown in FIG. 4, along with the results of the response delay time measurements (which will be described below).

### 2. Response Delay Time Measurements

Each of the air-fuel ratio sensors of Examples 1, 2 and the air-fuel ratio sensors of Comparative Examples 3, 4 was connected to a gas generator, and each air-fuel ratio sensor was exposed to a test gas containing H₂, CO, O₂, etc. The concentrations of H₂, CO, O₂, etc. in the test gas were gradually changed so that the test gas gradually changes from a lean atmosphere to a rich atmosphere, and changes in the output value of each air-fuel ratio sensor in response to changes in the air-fuel ratio of the test gas were monitored. In this manner, the length of time (response delay time) it took from a point in time at which the air-fuel ratio of the test gas in a lean region reached the stoichiometric point, to a point in time at which the air-fuel ratio (the actually measured air-fuel ratio) calculated based on the output value of the air-fuel ratio sensor changed from the stoichiometric point into a rich region was measured. The results of the response delay time measurements are shown in FIG. 4.

### 3. 50% Conversion Temperature Measurements

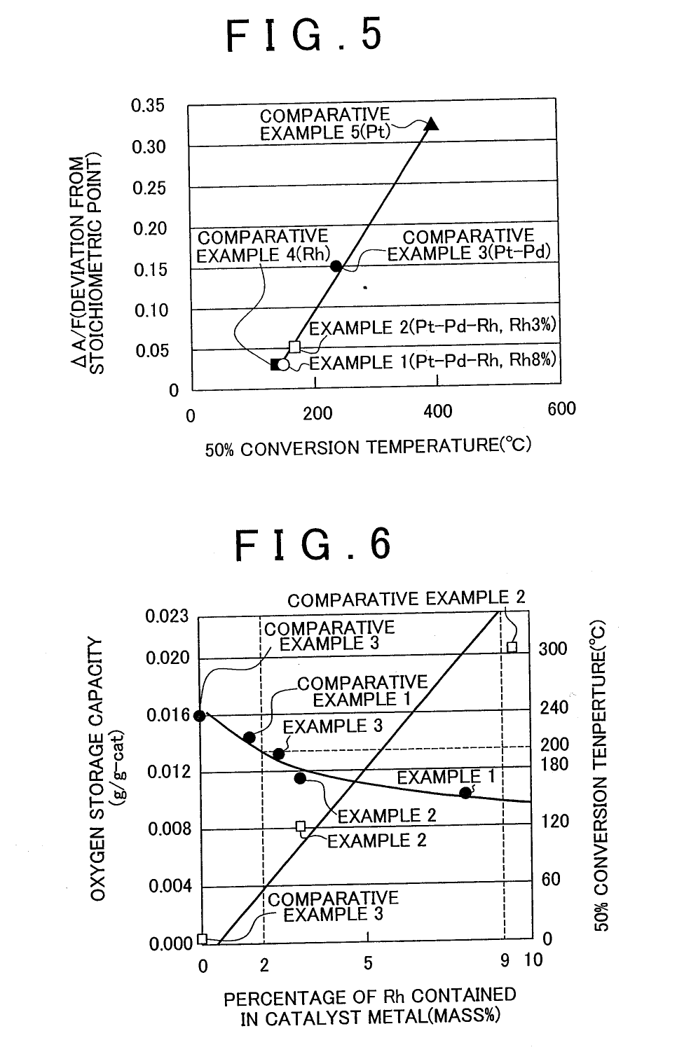

The 50% conversion temperature of the catalyst metal used in each of the air-fuel ratio sensors of Examples 1-3 and Comparative Examples 1-5 was measured, using the TRP (Temperature Programmed Reduction) method. More specifically, gases, such as H₂, CO and O₂, were passed through a pipe filled with the catalyst metal of each air-fuel ratio sensor, and an analyzer (quadrupole mass spectrometer, or QMS) was placed at the downstream side of the pipe as viewed in the direction of flow of the gas. Then, while heating the catalyst metal with an external heater so as to gradually increase the temperature of the catalyst metal, each gas was passed through the pipe filled with the catalyst metal, and the concentration of each gas flowing out of the pipe was monitored, whereby the temperature (i.e., 50% conversion temperature) of the catalyst metal at which 50% of H₂ gas was oxidized (or converted) was measured. The results of the 50% conversion temperature measurements are shown in FIG. 5, along with the results of the stoichiometric-ratio determination accuracy measurements (which will be described below).

### 4. Stoichiometric-ratio Determination Accuracy Measurements

H₂, CO, O₂, etc. were mixed together to prepare a mixed gas of a stoichiometric atmosphere (i.e., an atmosphere whose A/F is equal to 14.5). Each of the air-fuel ratio sensors of Examples 1, 2 and the air-fuel ratio sensors of Comparative Examples 3-5 was exposed to the mixed gas, and the air-fuel ratio (which may be referred to as “A/F”) of the mixed gas was measured. ΔA/F was calculated from a difference between the measurement value of each example of air-fuel ratio sensor and the theoretical (or stoichiometric) air-fuel ratio. It can be determined that as ΔA/F is closer to zero, the deviation of the measurement value of each air-fuel ratio sensor from the stoichiometric ratio is smaller, and the measurement accuracy of the air-fuel ratio sensor (which will be referred to as “stoichiometric-ratio determination accuracy”) is higher. The results of the stoichiometric-ratio determination accuracy measurements are shown in FIG. 5.

As shown in FIG. 4, there is a correlation between the oxygen storage capacity of the catalyst metal and the response delay time of the air-fuel ratio sensor. Namely, the response delay time of the air-fuel ratio sensor is longer as the oxygen storage capacity of the catalyst metal is higher. If the response delay time of the air-fuel ratio sensor is 50 milliseconds or shorter, the influence exerted upon combustion control of the internal combustion engine can be sufficiently reduced. As shown in FIG. 4, the response delay time of the air-fuel ratio sensor can be made equal to or shorter than 50 milliseconds if the oxygen storage capacity of the catalyst metal is made equal to or less than 0.023 (g/g^{-cat}).

As shown in FIG. 5, there is a correlation between the 50% conversion temperature of the catalyst metal and the accuracy (ΔA/F) in the determination of the stoichiometric ratio. Namely, ΔA/F is larger as the 50% conversion temperature of the catalyst metal is higher. If ΔA/F is equal to or smaller than 0.1, the influence exerted upon combustion control of the internal combustion engine can be sufficiently reduced. As shown in FIG. 5, ΔA/F can be made equal to or smaller than 0.1 if the 50% conversion temperature of the catalyst metal used in the air-fuel ratio sensor is equal to or lower than 200° C.

On the basis of the results of the above-described oxygen storage capacity measurements, response delay time measurements, 50% conversion temperature measurements and the stoichiometric-ratio determination accuracy measurements, the relationships between the oxygen storage capacity and 50% conversion temperature of the catalyst metal, and the percentage (mass %) of Rh contained in the catalyst metal are indicated in the graph of FIG. 6. If the percentage of Rh contained in the catalyst metal is equal to or higher than 2 mass %, the 50% conversion temperature of the catalyst metal is equal to or lower than 200° C., as indicated by black circles in FIG. 6. Therefore, if the percentage of Rh contained in the catalyst metal is equal to or higher than 2 mass %, ΔA/F is equal to or smaller than 0.1, and the deviation from the stoichiometric ratio can be sufficiently reduced.

If the percentage of Rh contained in the catalyst metal is equal to or lower than 9 mass %, the oxygen storage capacity of the catalyst metal is equal to or less than 0.023 (g/g^{-cat}), as indicated by white squares in FIG. 6. Therefore, if the percentage of Rh contained in the catalyst metal is equal to or lower than 9 mass %, the response delay time of the air-fuel ratio sensor can be made equal to or shorter than 50 milliseconds, and the delay in response of the air-fuel ratio sensor can be sufficiently reduced.

As is understood from the above results, the measurement-value deviation of the air-fuel ratio sensor (or deviation from the stoichiometric ratio) and the delay in response can be both reduced if the amount of Rh contained in the whole catalyst layer is controlled to within the range of 2 to 9 mass %. It is more preferable to control the amount of Rh contained in the whole catalyst layer to within the range of 2 to 5 mass %. It is further preferable to control the amount of Rh contained in the whole catalyst layer to within the range of 2 to 3 mass %.

The air-fuel ratio sensor of the present invention has a pair of detection electrodes, i.e., the measuring electrode and the reference electrode. The material of the detection electrodes may be selected from, for example, Pt, Pt—Pd alloy and other materials having high sensitivity to oxygen gas. Also, the air-fuel ratio sensor of the invention may be further provided with second and third detection electrodes for detecting another component or components contained in the exhaust gas.

The porous diffusion resistance layer is only required to cover faces (which will be referred to as “exposed faces”) of the measuring electrode other than its face that is in contact with the solid electrolyte layer. The porous diffusion resistance layer may cover the entire area of the exposed faces, or may cover only a part of the exposed faces. In other words, the porous diffusion resistance layer of the air-fuel ratio sensor of the invention may form only a part of walls (which will be referred to as “defining walls”) that define the exhaust-gas chamber, or may form all of the defining walls. While the exhaust-gas chamber of the air-fuel ratio sensor of the invention is preferably defined by the porous diffusion resistance layer and a layer or layers (e.g., gas-impermeable layer) other than the porous diffusion resistance layer, the exhaust-gas chamber may be defined solely by the porous diffusion resistance layer, depending on the average pore size or porosity, for example, of the porous diffusion resistance layer. While it is preferable that the entire area of the porous diffusion resistance layer is spaced from the exposed faces of the measuring electrode, the diffusion resistance layer may be in contact with a part of the exposed faces, for example, may be in contact with side faces of the measuring electrode.

The average pore size, porosity, and gas flow channel length of the porous diffusion resistance layer used in the air-fuel ratio sensor of the invention may be set as appropriate depending on the components contained in the exhaust gas of the vehicle on which the air-fuel ratio sensor of the invention is installed. The porous diffusion resistance layer may be made of a material, such as alumina or zirconia, which can form a porous structure.

In the air-fuel ratio sensor of the invention, outer faces (or surfaces) of the porous diffusion resistance layer opposite to its faces on the side where the measuring electrode is located are covered with the catalyst layer. The catalyst layer includes the base material and the catalyst metal, and permits gas to pass therethrough. The base material may be made of a material, such as alumina, zirconia or ceria, which can form a porous structure.

In the air-fuel ratio sensor of the invention, the Pt—Pd—Rh alloy is used as the catalyst metal supported on the base material. Of Pt, Pd and Rh that constitute the catalyst metal, Rh is contained in the amount of 2 to 9 mass % when the overall amount of the catalyst layer is represented as 100 mass %. While the percentages of Pt and Pd in the Pt—Pd—Rh alloy are not particularly limited, it is preferable that Pd is contained in the amount of 2-65 mass %, more preferably, 5-40 mass % when the overall amount of the catalyst layer is represented as 100 mass %. With Pd thus controlled to the above-indicated percentages, Pd is less likely or unlikely to evaporate or aggregate under an oxidation-reduction atmosphere. It is also preferable that Pt is contained so that Pd:Pt=1:4 to 5:5. With Pt thus controlled to the above-indicated ratio, Pt is less likely or unlikely to evaporate or aggregate under an oxidation-reduction atmosphere. Furthermore, it is preferable that the Pt—Pd—Rh alloy before it is supported on the base material has the average particle size of about 0.1 nm to 1000 nm.

While the average pore size, porosity, and gas flow channel length of the catalyst layer may be set as appropriate depending on the components contained in the exhaust gas of the vehicle on which the air-fuel ratio sensor of the invention is installed, it is preferable that the average pore size is about 0.1 to 10 μm, the porosity is about 40 to 70%, and that the gas flow channel length is about 10 to 300 μm. When alumina is used as a material of the base material, it is particularly preferable that the alumina has the average particle size of about 1 μm to 10 μm.

1. An air-fuel ratio sensor comprising:
a solid electrolyte layer;
a measuring electrode laminated on a first face of the solid electrolyte layer;
a reference electrode laminated on a second face of the solid electrolyte layer which is different from the first face thereof, such that the reference electrode and the measuring electrode are opposed to each other with the solid electrolyte layer interposed therebetween;
a porous diffusion resistance layer that permits gas to pass therethrough and covers the measuring electrode; and
a catalyst layer including a catalyst metal and a base material on which the catalyst metal is supported, the catalyst layer permitting gas to pass therethrough and covering the porous diffusion resistance layer,
wherein the catalyst metal comprises a platinum-palladium-rhodium alloy, and contains 2 to 9 mass % of the rhodium when the overall amount of the catalyst layer is represented as 100 mass %.

2. The air-fuel ratio sensor according to claim 1, wherein the rhodium is contained in the amount of 2 to 5 mass % when the overall amount of the catalyst layer is represented as 100 mass %.

3. The air-fuel ratio sensor according to claim 2, wherein the rhodium is contained in the amount of 2 to 3 mass % when the overall amount of the catalyst layer is represented as 100 mass %.

4. The air-fuel ratio sensor according to claim 1, wherein the palladium is contained in the amount of 2 to 65 mass % when the overall amount of the catalyst layer is represented as 100 mass %.

5. The air-fuel ratio sensor according to claim 4, wherein the palladium is contained in the amount of 5 to 40 mass % when the overall amount of the catalyst layer is represented as 100 mass %.

6. The air-fuel ratio sensor according to claim 4, wherein the mass ratio of the palladium to the platinum in the platinum-palladium-rhodium alloy is 1:4 to 5:5.

7. The air-fuel ratio sensor according to claim 1, wherein the catalyst layer has an average pore size of 0.1 μm to 10 μm.

8. The air-fuel ratio sensor according to claim 1, wherein the catalyst layer has a porosity of 40% to 70%.

9. The air-fuel ratio sensor according to claim 1, wherein the catalyst layer has a gas flow channel length of 10 μm to 300 μm.

10. The air-fuel ratio sensor according to claim 1, wherein alumina is used as a material of the base material, and the catalyst layer has an average particle size of 1 μm to 10 μm.

11. The air-fuel ratio sensor according to claim 1, wherein the porous diffusion resistance layer cooperates with the solid electrolyte layer to cover the measuring electrode.

12. The air-fuel ratio sensor according to claim 11, further comprising a shield layer that cooperates with the porous diffusion resistance layer and the solid electrolyte layer to cover the whole of the measuring electrode, the shield layer inhibiting gas from passing therethrough.

13. The air-fuel ratio sensor according to claim 1, wherein the catalyst layer covers the entire area of exposed faces of the porous diffusion resistance layer.
